(19) United States
(12) Patent Application Publication
(10) Pub. No.: US 2008/0019286 A1
(43) Pub. Date: Jan. 24, 2008

(54) Method and apparatus for optical network alarm/event management

(76) Inventors: Michael J. Wurst, Santa Rosa, CA (US); Marc R. Bernard, Miramar, FL (US); Thomas E. Conklin, Leesburg, VA (US); John A. Stock, Leesburg, VA (US); John C. Silovich, Fox Lake, IL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/490,871

(22) Filed: Jul. 21, 2006

(51) Int. Cl. H04L 12/28; H04L 12/56

(52) U.S. Cl. 370/254; 370/400

(57) ABSTRACT

Managing optical network alarms and events reported by multiple network nodes is described. In some embodiments, alarms or events of the same, similar, or different types are monitored and consolidated into a consolidated alarm or event. The consolidated alarms or events may be forwarded to another network node. An alarm or event storm in an optical network or other type of network can be significantly reduced, resulting in less consumption of network resources and simplified operation for a service provider. Details of the alarm storm can be retrieved on an as-needed basis.

### BACKGROUND OF THE INVENTION

A Fiber-to-the-Premises (FTTP) network architecture extends optical fiber directly to subscribers' premises. According to the FTTP network architecture, an Optical Network Terminal (ONT) is placed on the subscribers' premises. In a typical FTTP deployment, a single network element, such as an Optical Line Terminal (OLT), in a Central Office (CO) may monitor and manage active components of hundreds, thousands, or millions of ONTs. Under some network failure conditions, all of the ONTs may report the same failure condition at the same time. While this information is useful to a resolution of the failure condition, the simultaneous reporting of hundreds, thousands, or millions of alarms may quickly become a burden for an operator and the OLT.

### SUMMARY OF THE INVENTION

A network or corresponding method in accordance with an embodiment of the present invention reduces a number of Optical Network Terminal (ONT) failure conditions reported to an Optical Line Terminal (OLT) upstream of ONT(s). The OLT may monitor state indicators representing the status of at least a subset of multiple ONTs. The OLT may consolidate the state indicators into at least one consolidated state indicator based on a given state of at least one of the state indicators. The OLT may forward the at least one consolidated state indicator to a Management System (MS).

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a network diagram of an optical communications system, with an Optical Line Terminal (OLT) and multiple Optical Network Terminals (ONTs), employing an embodiment of the present invention;

FIGS. 1B and 1C are network diagrams of a portion of the optical communications system of FIG. 1A employing embodiments of the present invention;

FIG. 2 is a diagram of example registers of state indicators used in ONTs in an optical communications system;

FIG. 3 is a table of example ONT state indicators used in an optical communications system according to embodiments of the present invention;

FIG. 4 is a block diagram illustrating example components in a Passive Optical Network (PON) card in a communications path between an ONT and an OLT;

FIGS. 5-7 are example flow diagrams performed by elements of an optical communications system according to embodiments of the present invention;

FIGS. 8 and 9 are network diagrams of portions of an optical communications system illustrating alarm consolidation according to embodiments of the present invention;

FIGS. 10A-10G are network diagrams of a portion of an optical communications system illustrating clearing of state indicators and consolidated state indicators according to an embodiment of the present invention;

FIG. 11 is a table of example ONT state indicators used in an optical communications system according to embodiments of the present invention;

FIGS. 12A and 12B are network diagrams of a portion of an optical communications system illustrating alert consolidation according to an embodiment of the present invention; and

FIG. 13 is an example alert bit map for an optical communications system according to a further embodiment of the present invention.

### DETAILED DESCRIPTION OF THE INVENTION

A description of example embodiments of the invention follows.

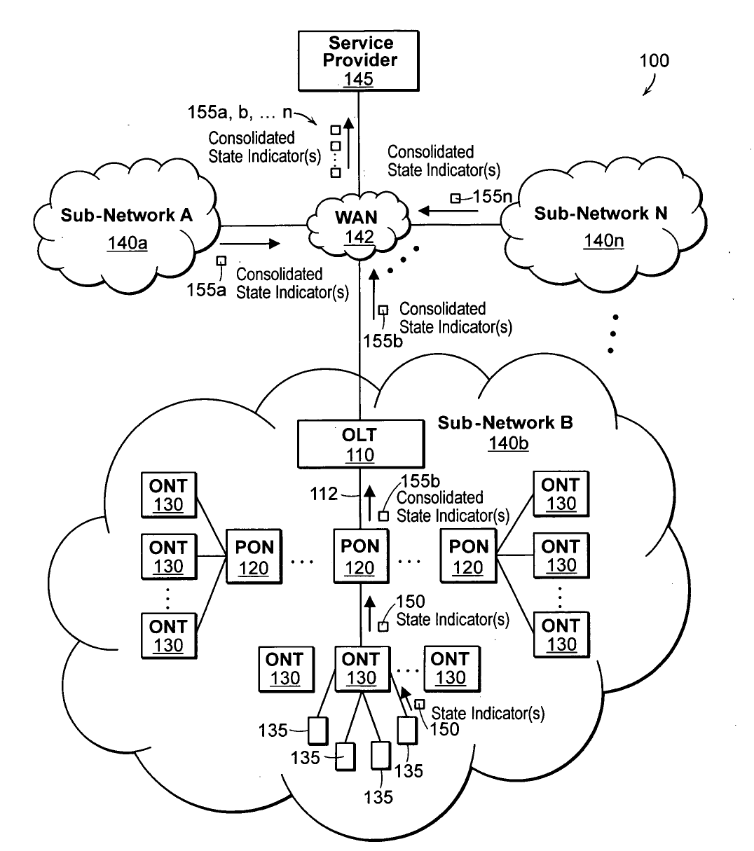

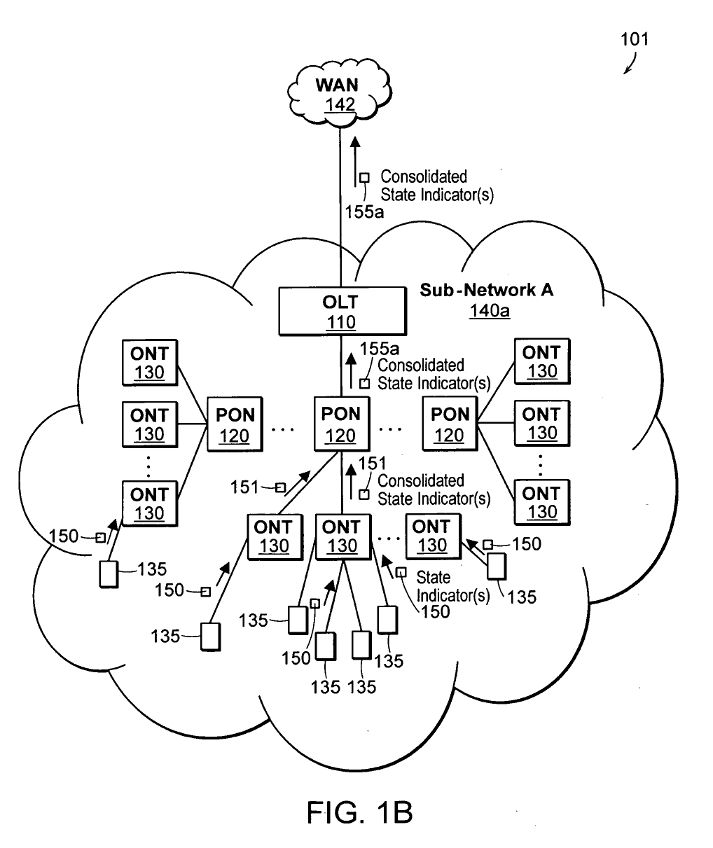

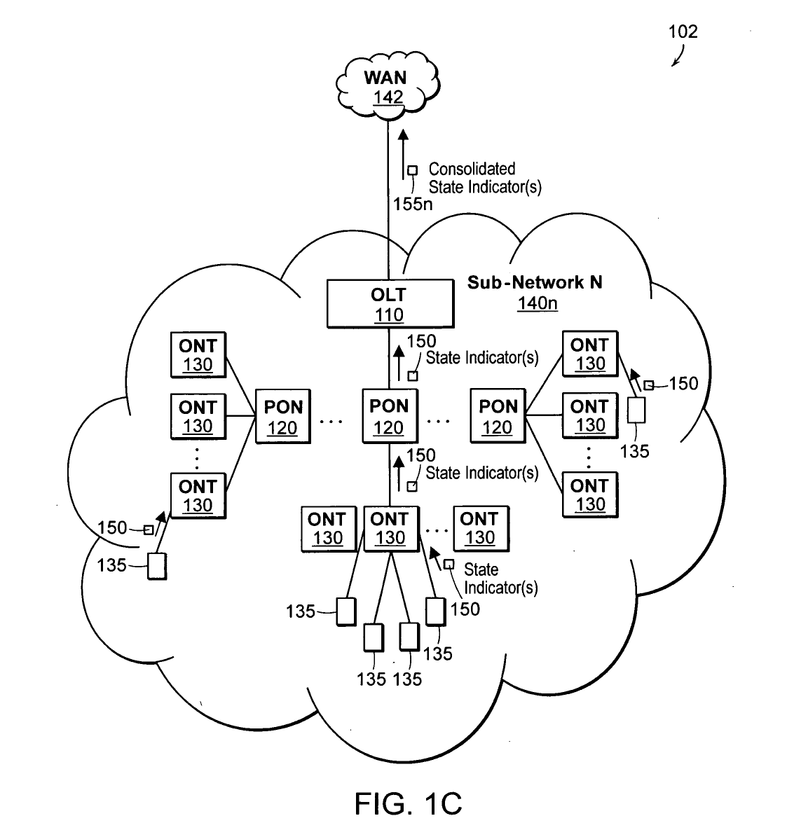

FIG. 1A is a network diagram of an optical communications system 100 employing an embodiment of the present invention. The optical communications system 100 includes multiple sub-networks 140a, 140b, . . . , 140n (Sub-Network A, Sub-Network B, . . . Sub-Network N) connected to a service provider 145 through a Wide Area Network (WAN) 142. A sub-network, such as Sub-Network B 140b, may include an Optical Line Terminal (OLT) 110, multiple Passive Optical Network (PON) cards 120 (“PON”), multiple Optical Network Terminals (ONTs) 130 connected to each PON card 120, and multiple network devices 135 connected to each ONT 130. This network configuration allows the service provider 145 to manage the large number of OLTs 110, PON cards 120, ONTs 130, and network devices 135 in the optical communications system 100.

In one embodiment of the optical communications system 100, fifty-two PON cards 120 may connect to an OLT 110 via a network link 112 or, in another embodiment, the PON cards 120 may be physically co-located in a chassis (not shown) with an OLT 110. Any number of ONTs 130 (e.g., thirty-two or sixty-four ONTs), in turn, may connect to each PON card 120. Finally, each ONT 130 may support four network devices 135, such as a computer, video device, alarm system, or telephone, via four interfaces (not shown). Thus, an OLT 110 may connect to 52 (PONs)×32 (ONTs)=1664 ONTs 130 or 1664 (ONTs)×4 (interfaces or network devices)=6656 network devices 135, and each managed entity (i.e., the OLTs 110, PON cards 120, ONTs 130, and network devices 135) can provide state indicators representing its status.

In another embodiment, the network devices 135 may represent interfaces (not shown) that are integrated into a given ONT 130. For example, Session Initiation Protocol (SIP) and Multimedia over Coax Alliance (MoCA) technology may be integrated into the given ONT 130. Thus, an ONT 130 may provide the operational state of an interface (i.e., on or off) as a state indicator.

The state indicators may represent an alarm state, an alarm reset state, or a non-alarm event. The non-alarm event may include a threshold crossing alert indicating that a given threshold has been exceeded.

In the embodiment of FIG. 1A, a PON card 120 may receive state indicators 150 from all network devices 135 via ONTs 130 and provide a consolidated state indicator(s) 155b to OLT 110. The OLT 110, in turn, may forward the consolidated state indicator(s) 155b to the service provider 145 via the WAN 142. In this manner, sub-networks 140a, 140b, . . . , 140n may forward respective consolidated state indicators 155a, 155b, . . . , 155n to the service provider 145.

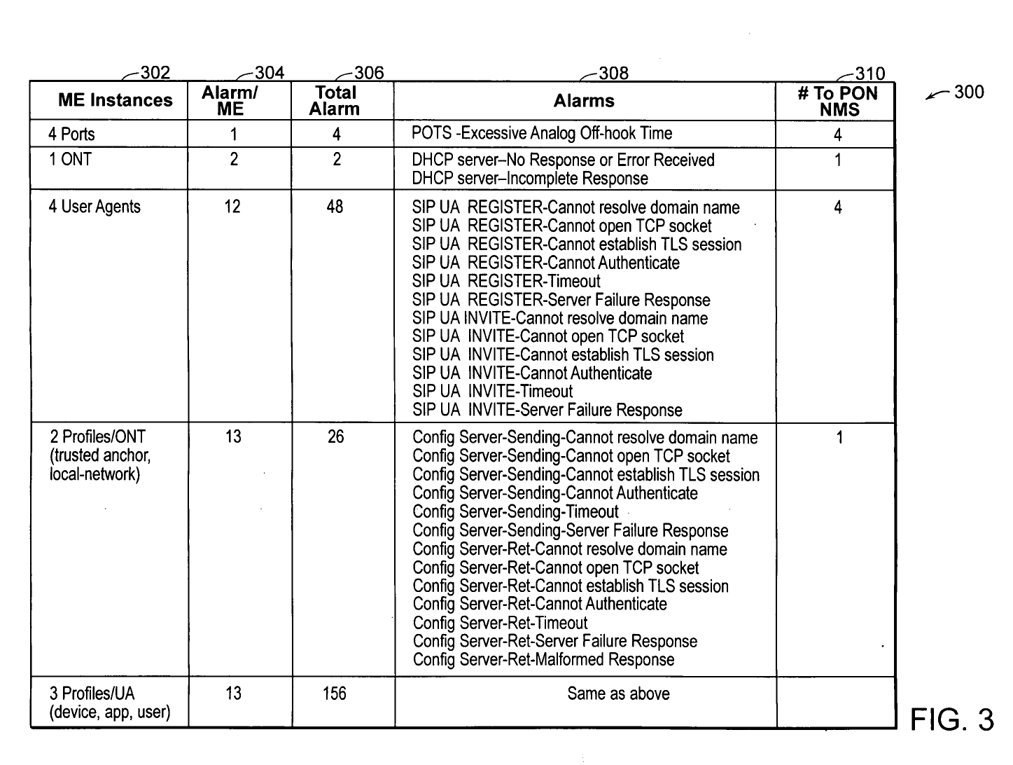

FIG. 1B is a network diagram of a portion 101 of the optical communications system 100 of FIG. 1A in which an ONT 130 may consolidate state indicators 150 from subtending network devices 135 and forward consolidated state indicator(s) 151. The ONT 130 may consolidate the state indicators 150 by enforcing a hierarchy of alarms and forwarding the most severe alarm for any given alarm type. For example, the ONT 130 may forward one Dynamic Host Configuration Protocol (DHCP) server-type alarm, four SIP UA-type alarms, and one Config Server-type alarm as indicated in column 310 of FIG. 3 (six total alarms). As a result, in this example, the maximum number of SIP alarms that may be received by a PON Management System (MS) is reduced from 392,704 SIP alarms to 6 (SIP alarms)×1664 (ONTs)=9,984 SIP alarms.

In other embodiments, network elements at higher levels may further consolidate consolidated state indicators from subtending network elements. For example, a PON card 120 may receive multiple consolidated state indicators 151 from subtending ONTs 130 and provide further consolidated state indicator(s) 155a to an OLT 110. The OLT 110, in turn, may receive the further consolidated state indicator(s) 155a and forward them to the WAN 142 for delivery to, for example, a Management System (MS) or other network node for inspection by or informing of a service provider or third party network management organization.

FIG. 1C is a network diagram of another portion 102 of the optical communications system 100 of FIG. 1A. In this embodiment, PON cards 120 and ONTs 130 forward state indicators 150 from subtending network devices 135 to the OLT 110. The OLT 110 consolidates the state indicators 150 and forwards consolidated state indicator(s) 155n to the service provider 145 via the WAN 142.

The OLTs 110, PON cards 120, or ONTs 130 may maintain the alarm states of a subset of all network devices 135. In this way, a user may retrieve “on demand” detailed alarm information, such as the current alarm state, from the OLTs, PON cards, or ONTs through an MS.

Briefly, high level differences in example embodiments among the networks 100, 101, and 102 of FIGS. 1A, 1B, and IC, respectively, are indicated in the following table:

| | FIG. 1A, | FIG. 1B, | FIG. 1C, |
|---|---|---|---|
| | network 100 | network 101 | network 102 |
| Initial State Indicator | At PONs 120 | At ONTs 130 | At OLTs 110 |
| Consolidation | | | |

It should be understood that further state indicator consolidation may occur at hierarchical level(s) beyond the level where the initial state indicator consolidation occurs. In addition, each network node may be equipped to generate state indicators. Thus, there may be an initial state indicator consolidation or a further consolidation of consolidated state indicators at each hierarchical level.

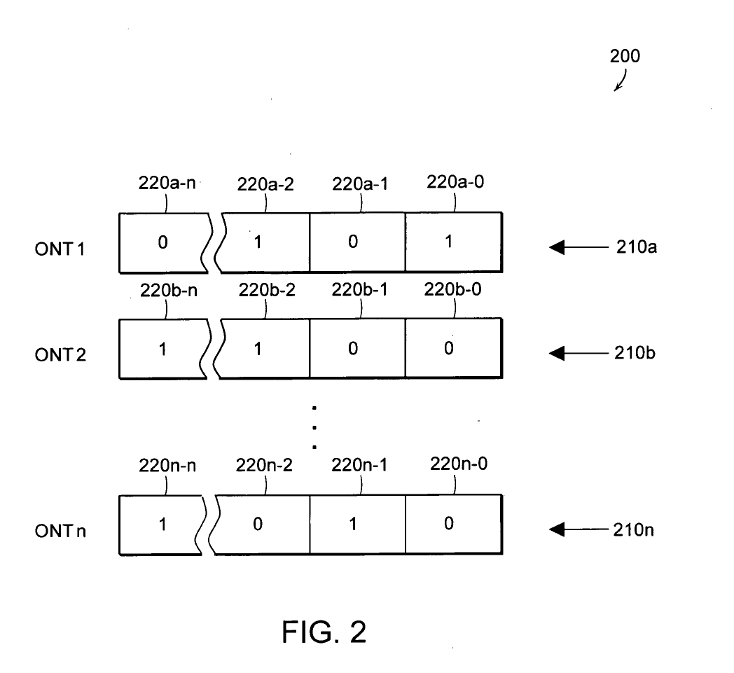

FIG. 2 is an example diagram of registers of state indicators 200 associated with ONTs, such as the ONTs 130 in the optical communications system 100 of FIG. 1A.

Registers 210a, 210b, . . . , 210n, associated with respective ONTs 1, 2, . . . , n, may indicate a status of various aspects of the ONTs 1, 2, . . . , n by setting bits in register cells 220a-0, 220a-1, . . . , 220a-n; 220b-0, 220b-1, . . . , 220b-n; and so forth, where the bits, or combinations of bits, represent state indicators. The state of various aspects of the ONTs may be representative of a state of communications readiness, port traffic level, alarm state, and so forth. Again, individual register cells 220a-0, 220a-1, etc. may represent a state of the network device with which they are associated, or multiple register cells may be treated as a hexadecimal value, for example, to represent a state.

FIG. 3 is a table 300 of example state indicators, such as state indicators represented in the registers 210a, 210b, . . . , 210n in FIG. 2, of an ONT 130 according to one embodiment of the present invention. The state indicators may include Session Initiation Protocol (SIP) alarms used in Voice-Over-IP (VoIP) applications. The table 300 may include columns indicating Managed Entity (ME) Instances 302, number of alarms per ME Instance 304, total number of alarms 306, listing of the alarms 308, and number of alarms 310 that an ONT may forward to a PON Management System (MS).

Examples of the SIP alarms may include an alarm associated with each interface or port of an ONT that indicates an ONT hardware or software failure or a user's failing to hang up a telephone device (e.g., “POTS—Excessive Analog Off-hook Time”). Examples of the SIP alarms may also include: (1) two Dynamic Host Configuration Protocol (DHCP) server-type alarms associated with each ONT (2 total alarms); (2) twelve SIP User Agent (UA) alarms associated with each of four UAs (48 total alarms); (3) thirteen Configuration Server alarms associated with each of a trusted anchor profile and a local-network profile of an ONT (26 total alarms); and (4) thirteen Configuration Server alarms associated with each of a device profile, an application profile, and a user profile for each of the four UAs (4 UAs×39 alarms=156 total alarms). Thus, each ONT may generate up to two hundred thirty-six (236) SIP alarms, and an OLT connected to one thousand six hundred sixty-four (1664) ONTs may receive up to 236×1664=392,704 SIP alarms.

Under normal circumstances, a network operator or automated management system at a central office, monitoring ONTs through a computer terminal (not shown) connected to an OLT, receives a manageable number of alarms. However, a single network event, such as a router failure, can cause an “alarm storm” of hundreds, thousands, or millions of alarms. A network operator receiving such a large volume of alarms may find it difficult and time-consuming to diagnose network issues and respond accordingly. In addition, a large number of alarms may overwhelm MS resources.

In existing systems, each subtending network element (e.g., ONT) reports all alarms to the carrier MS. Then, the MS correlates alarms from the network and completes a root cause analysis.

According to embodiments of the present invention, an ONT 130, PON card 120, or OLT 110 may consolidate (or “roll-up”) multiple state indicators, such as alarms, by forwarding one alarm, a subset of alarms, or a representative alarm indicator for each alarm type declared on subtending network elements, e.g., network devices 135, ONTs 130, or PON cards 120, respectively.

It should be understood that alarms are being used in this description as an example only. In every instance of “alarm” or at least certain instances of “alarm,” the term “alarm” may be replaced with “event” or a combination of “alarms and events,” including cases where the term “alarm” is used as a modifier, such as alarm registers, alarm processing, alarm components, and so forth. Moreover, a state indicator may represent a set state (e.g., alarm active) or a reset state (e.g., alarm inactive).

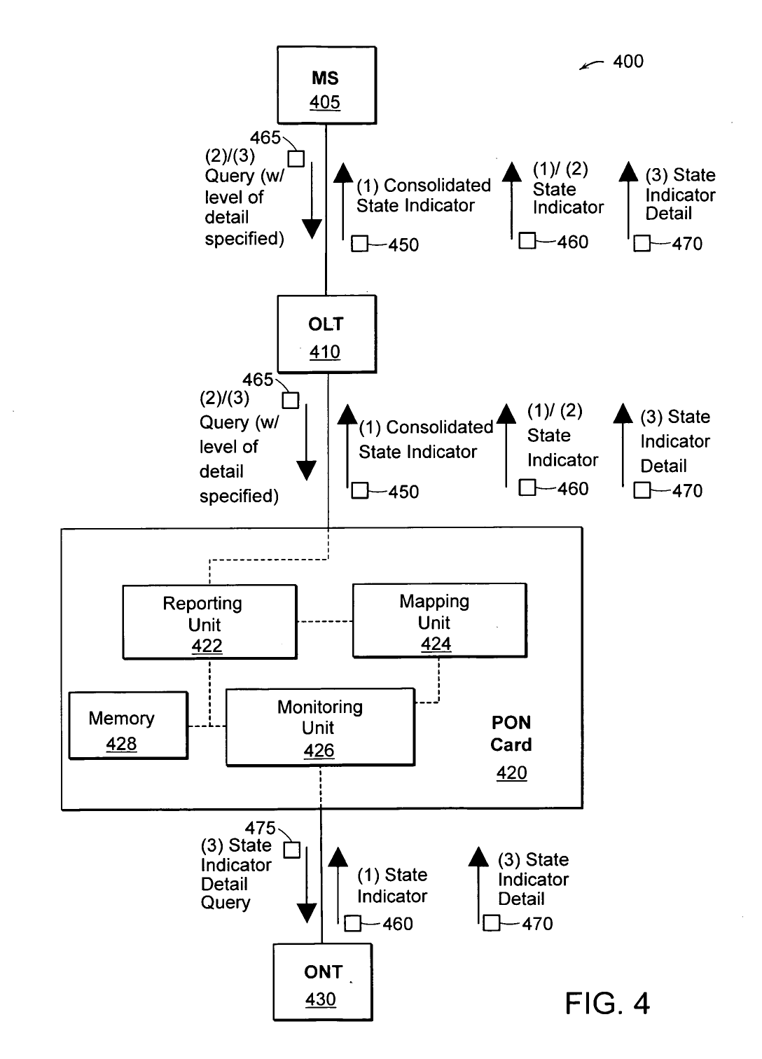

FIG. 4 is a network diagram of a portion of an optical communications system 400, such as the optical communications system 100 of FIG. 1, illustrating how state indicators or details of the state indicators may be retrieved according to one embodiment of the present invention. An ONT 430 may forward a state indicator packet 460, or other form of communication that may be used to transport a state indicator between network nodes, to a PON card 420. The PON card 420 may, in turn, consolidate the state indicator(s) contained in the state indicator packet 460 and forward a consolidated state indicator packet 450 or pass through the state indicator packet 460 to a Management System (MS) 405 via an OLT 410. The MS 405 includes Element Management Systems (EMSs) and Network Management Systems (NMSs). The EMSs manage the same type of devices whereas the NMSs manage different types of devices.

The PON card 420 may include a reporting unit 422, a mapping unit 424, a monitoring unit 426, and memory 428. The monitoring unit 426 may provide the state indicator packet 460 to the mapping unit 424, which maps the state indicator 460 to a consolidated state indicator 450. The mapping unit 424, in turn, may provide the consolidated state indicator 450 to the reporting unit 422. The reporting unit 422 may then forward the consolidated state indicator 450 to the MS 405 via the OLT 410. The monitoring unit 426 may detect additional occurrences of the state indicator 460 from other ONTs (not shown) in communication with the PON card 420. In this case, the monitoring unit 426 may store the additional occurrences of the state indicator 460 in the memory 428.

An operator or an automated management system of the MS 405 may query the PON card 420 through the OLT 410 for a specified level of detail (465) of the consolidated state indicator 450. For example, the operator may make a query to the PON card 420 for the state indicator 460. The PON card may then provide the state indicator 460 to the OLT 410 and MS 405 through the reporting unit 422. The operator may query (465) the PON card 420 through the OLT 410 for further details about the state indicator 460. The PON card 420, in turn, may query (475) the ONT 430 for details about the state indicator 460. In response to the query, the ONT 430 may provide the state indicator details 470 to the PON card 420. The PON card 420, in turn, may provide the state indicator details 470 to the OLT 410 and MS 405 through the reporting unit 422.

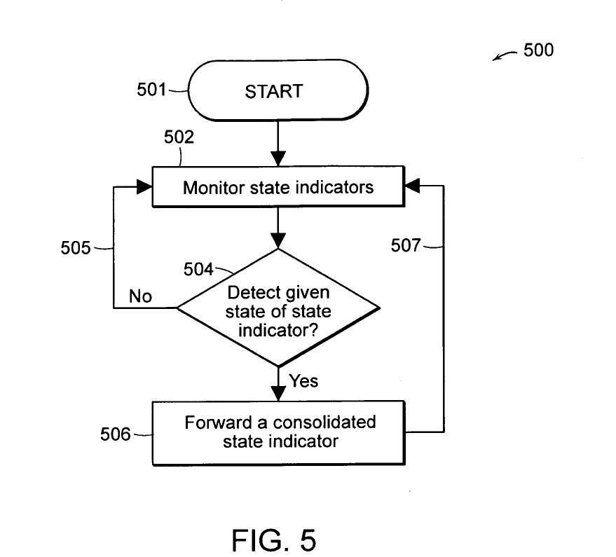

FIG. 5 is an example flow diagram performed by elements of an optical communications system according to one embodiment of the present invention. After starting (501), a second network node or entity, such as a PON card, monitors state indicators (502) in multiple first network nodes or entities, such as ONTs, in communication with the second network node. The second network node forwards a consolidated state indicator (506) in response to detecting a given state of the state indicators (504) in at least one of the multiple first network nodes. The second network node may aggregate the state indicators or alarms of a similar type into a “meta” or consolidated state indicator or alarm. Thereafter, the second network node resumes (507) monitoring the state indicators (502) in the multiple first network nodes.

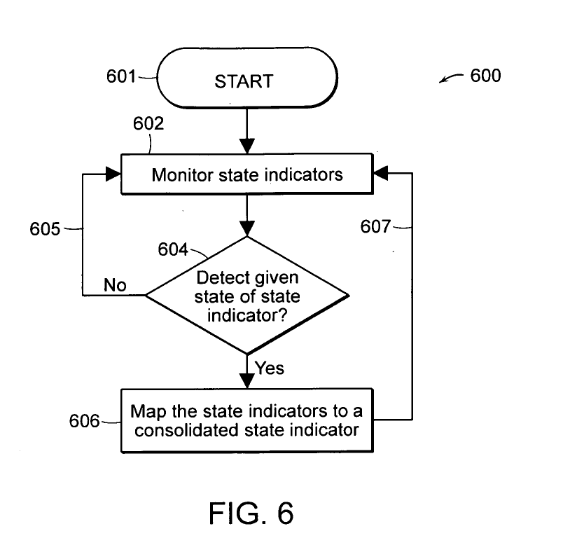

FIG. 6 is another example flow diagram 600 performed by network elements of an optical communications system, such as the optical communications system 100 of FIG. 1A. After starting (601), a second network node, such as a PON card of an OLT, monitors state indicators (602) in multiple first network nodes, such as ONTs, in communication with the second network node. The second network node may map or otherwise associate the state indicators to or with a consolidated state indicator (606) in response to detecting the state indicators (604) in at least one of the multiple first network nodes. The second network node may thereafter resume (605) monitoring the state indicators (602) in the multiple first network nodes.

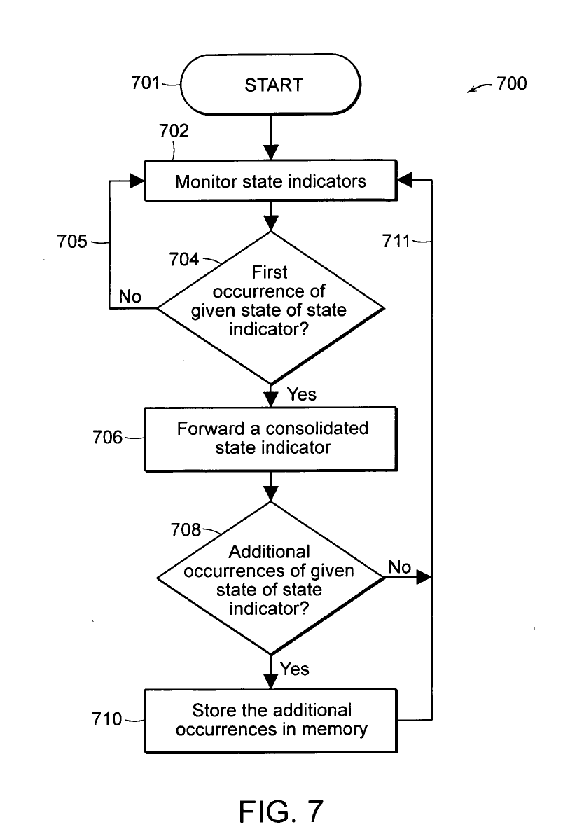

FIG. 7 is another example flow diagram 700 performed by elements of an optical communications system. After starting (701), a second network node, such as a PON card of an OLT, monitors state indicators (702) in multiple first network nodes, such as ONTs, in communication with the second network node. The second network node may forward a consolidated state indicator (706) in response to detecting a first occurrence of a given state of the state indicators (704) in the multiple first network nodes. A given state may be an alarm state, event state, or other state that is predetermined or adaptively learned by the second network node or a network node assisting with or contributing to an aspect of the network nodes described in reference to the flow diagram 700. In this example embodiment, the second network node does not forward additional occurrences (708) of the state indicator, and stores (710) the additional occurrences of the given state of the state indicators in memory. The second network node may thereafter resume (711) monitoring the state indicators (702) in the multiple first network nodes.

The second network node or entity may be an OLT, a PON card, or an ONT. The first network nodes or entities may be one or more PON cards, ONTs, or network devices in communication with an ONT.

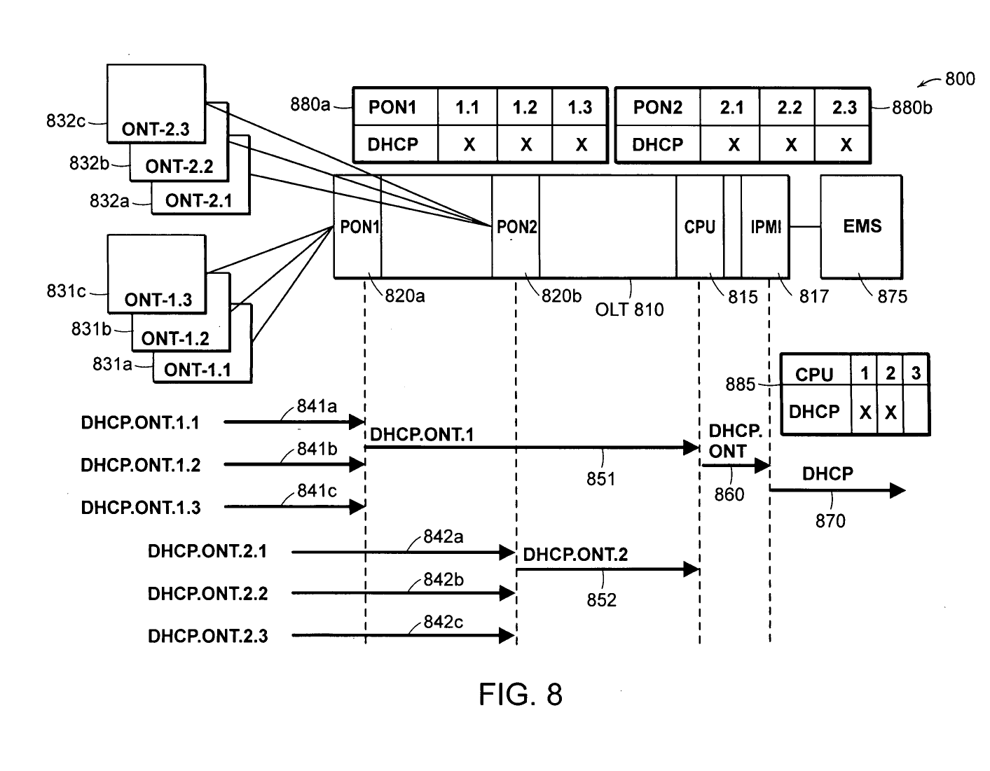

FIG. 8 is a network diagram of a portion of an optical communications system 800 illustrating alarm consolidation according to one embodiment of the present invention. The portion of the optical communications system 800 includes an OLT 810 and a Management System (“MS”) 875 used in Fiber-to-the-X (FTTX) network applications, where “X” may be “curb,” “premises,” or other edge location to which a fiber network extends. The OLT 810 and MS 875 may be located at a Central Office (CO), or may be located at separate facilities. The OLT 810 in this embodiment includes PON cards 820a-b (“PON1” and “PON2”), OLT processor 815 (“CPU”), and Internet Protocol Management Interface (“IPMI”) 817. The OLT 810 communicates with the EMS 875 via the IPMI 817.

The PON card 820a (“PON1”) communicates with multiple ONTs 831a-c (“ONT-1.1,” “ONT-1.2,” and “ONT-1.3”) and the other PON card 820b (“PON1”) communicates with multiple ONTs 832a-c (“ONT-2.1,” “ONT-2.2,” and “ONT-2.3”). In one embodiment, the PON cards 820a-b forward consolidated state indicators or alarms, such as consolidated Dynamic Host Configuration Protocol (DHCP) server alarms 851, 852 (“DHCP.ONT.1” and “DHCP.ONT.2”), respectively, when they receive multiple state indicators or alarms of the same type. For example, the PON card 820a may receive multiple DHCP alarms 841a-c (“DHCP.ONT-1.1,” “DHCP.ONT-1.2,” and “DHCP.ONT-1.3”) from respective ONTs 831a-c and the other PON card 820b may receive multiple DHCP alarms 842a-c (“DHCP.ONT-2.1,” “DHCP.ONT-2.2,” and “DHCP.ONT-2.3”) from respective ONTs 832a-c. In another embodiment, the PON cards 820a-b may forward a number of consolidated state indicators or alarms that are fewer in number than received state indicators or alarms.

The OLT processor 815 (“CPU”), in turn, forwards a further consolidated alarm, such as a further consolidated DHCP alarm 860 (“DHCP.ONT”), to the IPMI 817 when the OLT processor 815 receives the consolidated alarms, such as DHCP alarms 851, 852 (“DHCP.ONT.1” and “DHCP.ONT.2”), from the PON cards 820a-b, respectively. The IPMI 817 may then forward a DHCP alarm 870 (“DHCP”), representing the further consolidated DHCP alarm 860 (“DHCP.ONT”), to the EMS 875.

In other embodiments, the PON cards 820a-b or OLT processor 815 may detect the state indicators or alarms in the ONTs 831a-c, 832a-c or PON cards 820a-b, respectively. The PON cards 820a-b and OLT processor 815 may track or store alarms using tables or scorecards 880a-b, 885. As shown, for example, in FIG. 8, the PON card scorecards 880a-b indicate that DHCP alarms have been received from all ONTs 831a-c, 832a-c connected to respective PON cards 820a-b. Moreover, the OLT processor's scorecard 885 indicates that DHCP alarms have been received from PON cards 820a-b.

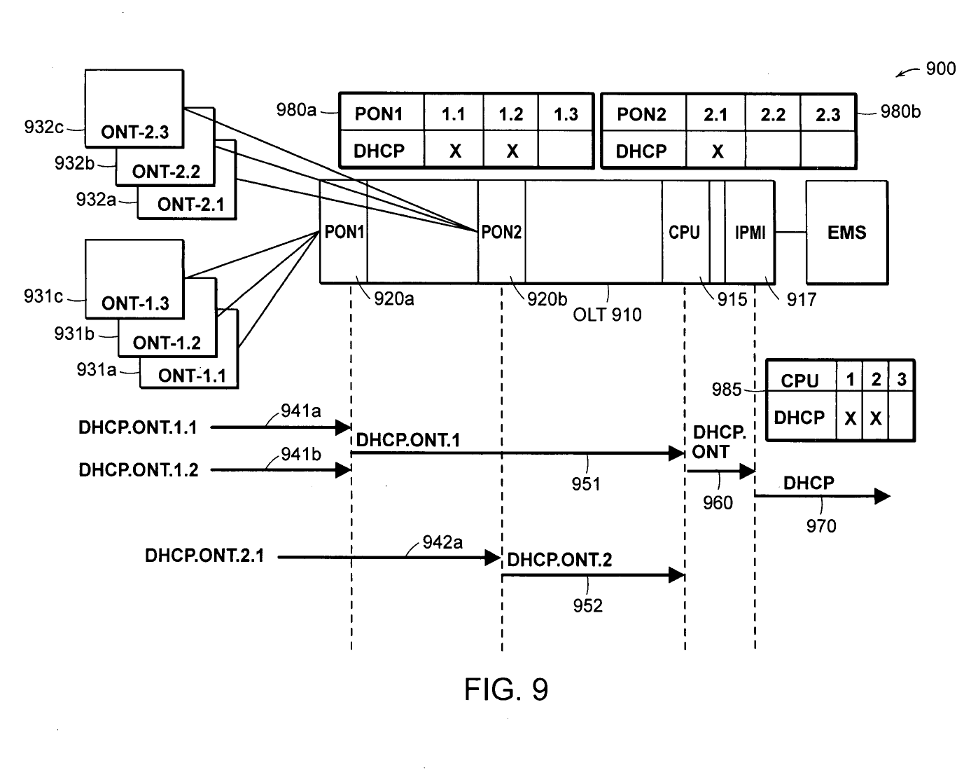

FIG. 9 is a network diagram of a portion of an optical communications system 900 illustrating alarm consolidation according to another embodiment. PON cards 920a-b (“PON1” and “PON2”) and OLT processor 915 (“CPU”) in an OLT 910 may each forward a consolidated alarm upon receiving an alarm for the first time. Any subsequent alarms may be recorded in PON card and OLT processor memory (not shown). For example, the PON card 920a (“PON1”) may forward a consolidated Dynamic Host Configuration Protocol (DHCP) alarm 951 (“DHCP.ONT.1”) to the OLT processor 915 (“CPU”) upon receiving a first DHCP alarm, such as DHCP alarm 941a (“DHCP.ONT-1.1”), from a subtending ONT, such as ONT 931a (“ONT-1.1”). The PON card 920a (“PON1”) may responsively make an indication in its scorecard 980a that the DHCP alarm 941a has been received (e.g., by adding an “X” to the column labeled “1.1”).

The OLT processor 915, in turn, forwards a further consolidated DHCP alarm 960 (“DHCP.ONT”) to an IPMI 917 upon receiving a first consolidated DHCP alarm, such as consolidated DHCP alarm 951 (“DHCP.ONT.1”), from a subtending PON card, such as PON card 920a. The OLT processor 915 may responsively make an indication in its scorecard 985 that the consolidated DHCP alarm 951 has been received from PON card 920a (e.g., by adding an “X” to the column labeled “1”).

When PON card 920a receives a second DHCP alarm 941b (“DHCP.ONT-1.2”) from ONT 931b (“ONT-1.2”), it may make an indication in its scorecard 980a that the second DHCP alarm 941b (“DHCP.ONT-1.2”) has been received (e.g., by adding an “X” to the column labeled “1.2”). The PON card 920a, however, does not forward the second DHCP alarm 941b or any other DHCP alarms of the same type to the IPMI 917.

In a similar manner, the other PON card 920b (“PON2”) may forward a second consolidated DHCP alarm 952 (“DHCP.ONT.2”) to the OLT processor 915 (“CPU”) upon receiving a first DHCP alarm, such as DHCP alarm 942a (“DHCP.ONT-2.1”), from a subtending ONT, such as ONT 932a (“ONT-2.1”). As shown in FIG. 9, the PON card 920b (“PON2”) may indicate in its scorecard 980b that the DHCP alarm 942a has been received (e.g., by adding an “X” to the column labeled “2.1”). When the OLT processor 915 receives additional consolidated alarms of the same type, such as the second consolidated DHCP alarm 952, from subtending PON cards, such as PON card 920b, the OLT processor 915 (“CPU”) may indicate in its scorecard 985 that the additional consolidated alarms, such as the second consolidated DHCP alarm 952, have been received (e.g., by adding an “X” to the column labeled “2”). The OLT processor 915, however, does not forward the additional consolidated alarms of the same type, such as the second consolidated DHCP alarm 952, to the IPMI 917.

As described above, the state indicator may represent an alarm state. The state indicator may also represent an alarm reset state. For example, each ONT may generate an instance of an alarm reset state (e.g., an alarm clear). Each PON card, in turn, may generate an alarm reset state when all ONTs communicating with that PON card have generated an instance of an alarm reset state. In another embodiment, each PON card may generate an alarm reset state when the number of ONTs communicating with that PON card is less than a given threshold. For example, if a given number of non-critical alarms is fewer than a threshold (e.g., 3) in a system in which many non-critical alarms are possible (e.g., 10), then an embodiment of the PON card does not generate an alarm until at least the threshold number of alarms are detected. An OLT, in turn, may generate an alarm reset state when all PON cards with outstanding alarm states have generated an instance of an alarm reset state or when the number is less than a given threshold. Other methodologies may also be implemented to improve system or network level performance.

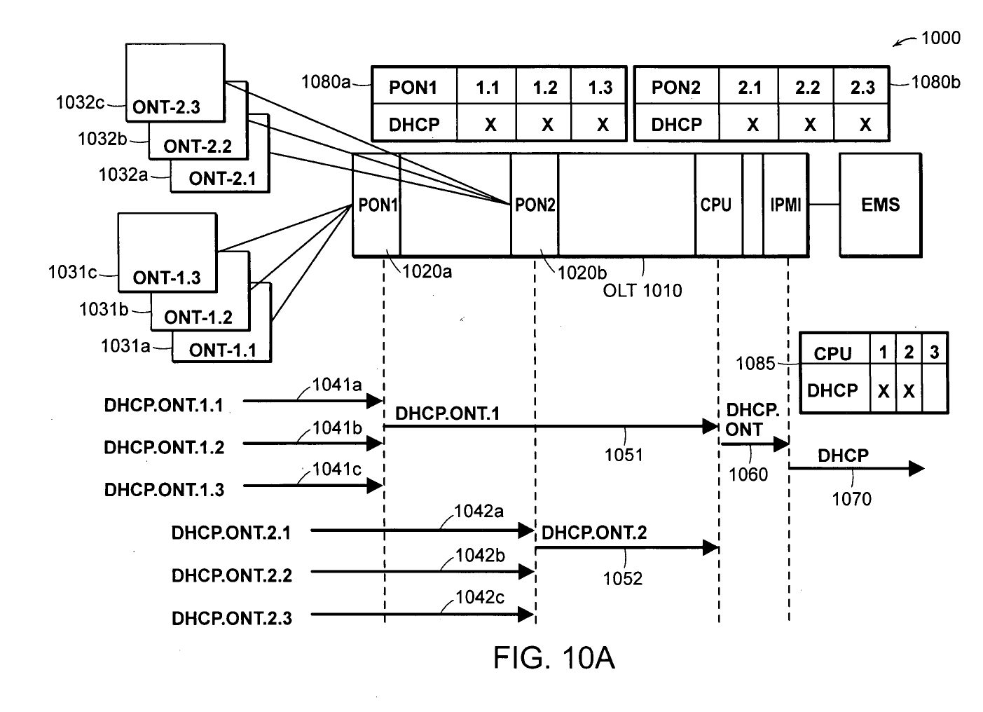

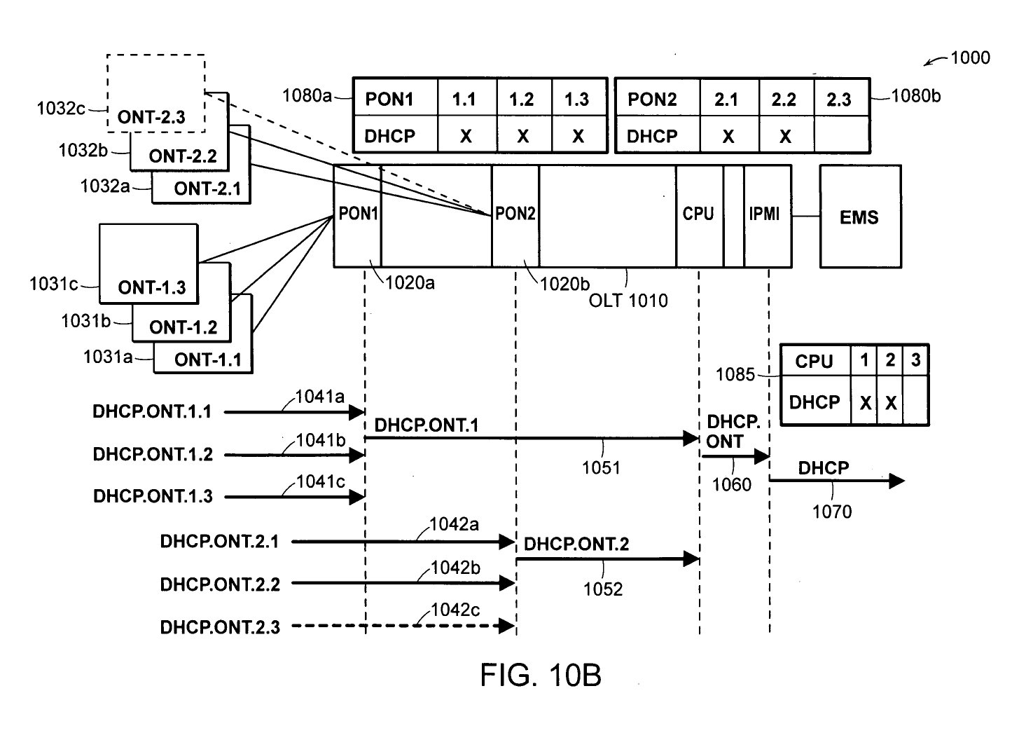

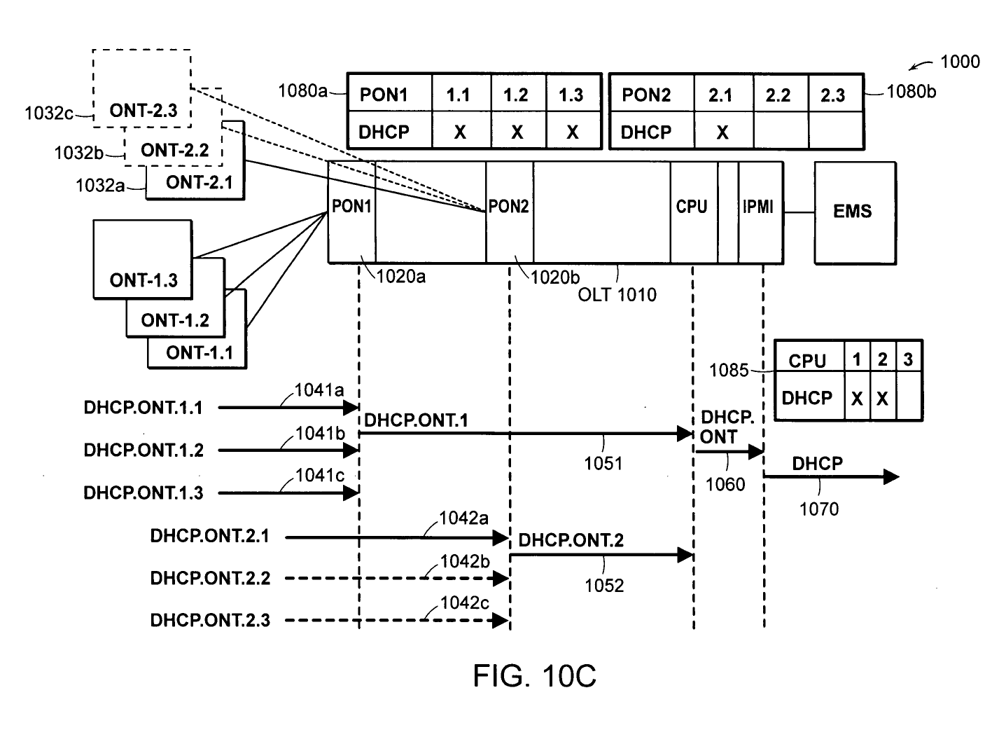

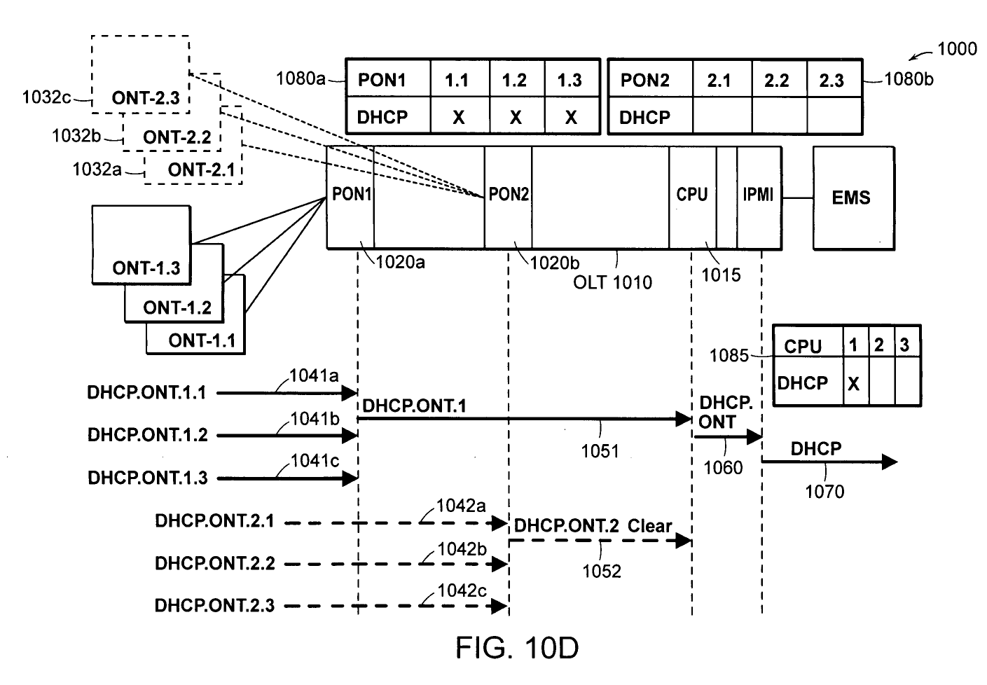

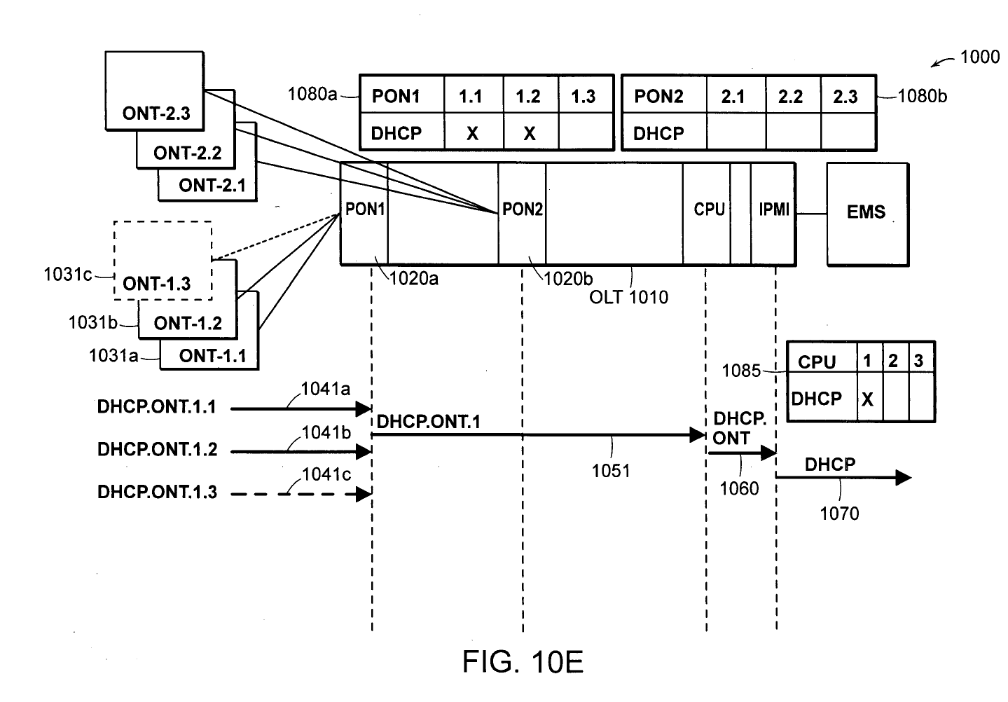

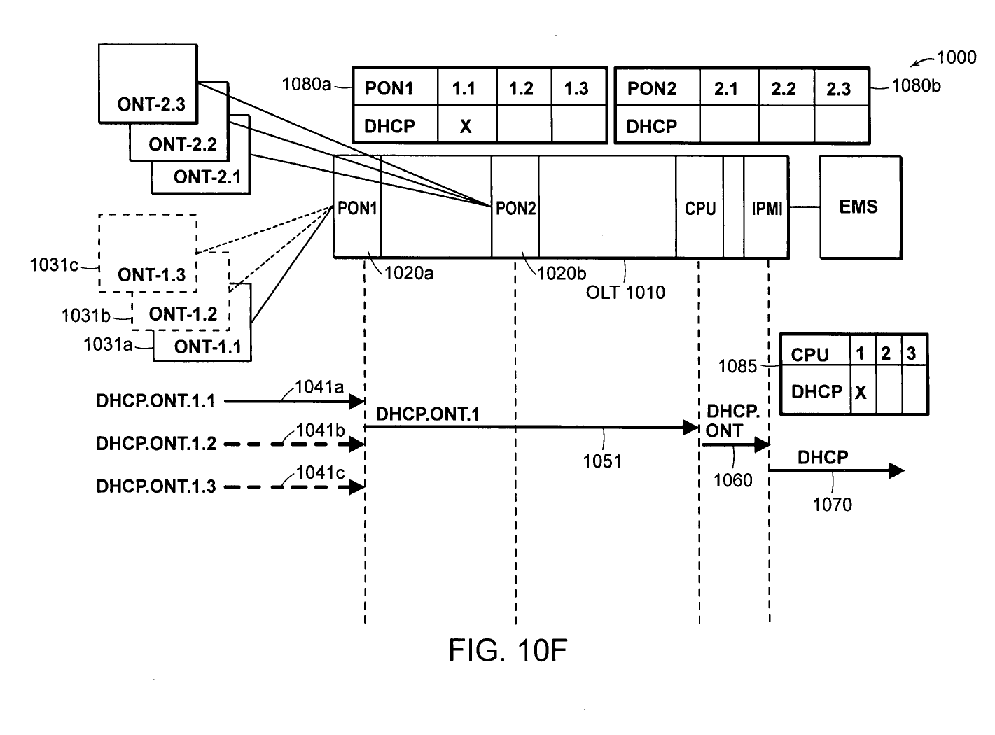

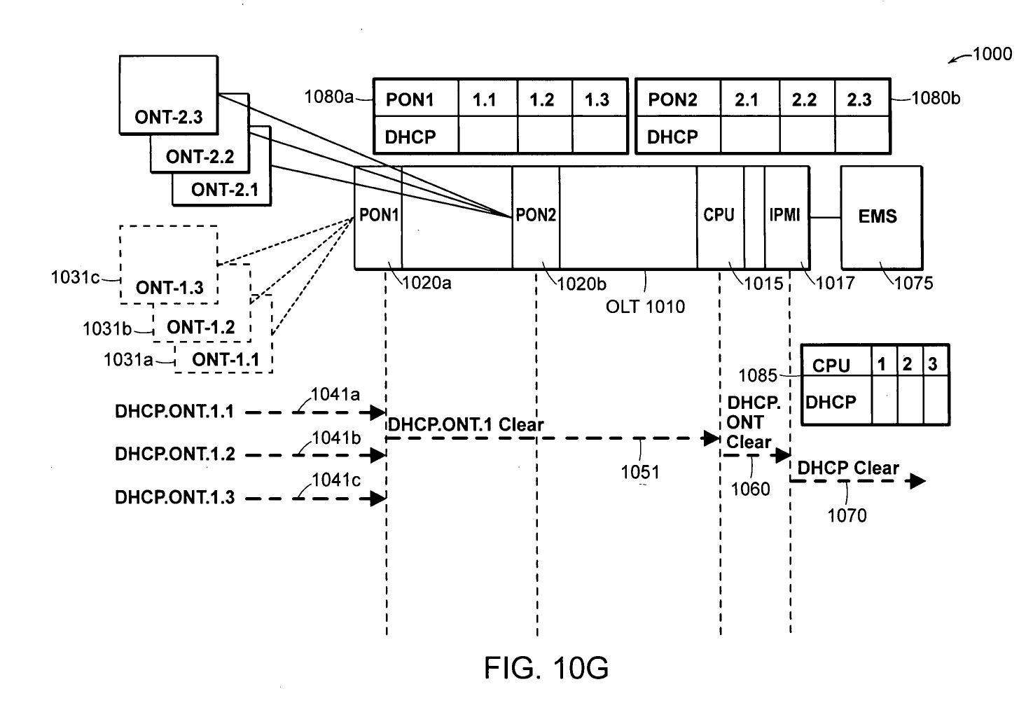

FIGS. 10A-10G are network diagrams of a portion of an optical communications system 1000 illustrating the clearing of alarms and consolidated alarms according to an embodiment of the present invention.

As shown in FIG. 10A, DHCP alarms 1041a-c (“DHCP.ONT-1.1,” “DHCP.ONT-1.2,” and “DHCP.ONT-1.3”) and 1042a-c (“DHCP.ONT-2.1,” “DHCP.ONT-2.2,” and “DHCP.ONT-2.3”) associated with ONTs 1031a-c (“ONT-1.1,” “ONT-1.2,” and “ONT-1.3”) and 1032a-c (“ONT-2.1,” “ONT-2.2,” and “ONT-2.3”), respectively, are in a set state (e.g., an outstanding alarm state). As further shown in FIG. 10A, consolidated DHCP alarms 1051, 1052 (“DHCP.ONT.1” and “DHCP.ONT.2”) from respective PON cards 1020a-b (“PON1” and “PON2”) and further consolidated DHCP alarms 1060, 1070 (“DHCP.ONT” and “DHCP”) are in the set state.

Referring to FIG. 10B, when a failure condition associated with the set state of the DHCP alarm 1042c is resolved, the ONT 1032c changes the DHCP alarm 1042c to a reset state as indicated by a dashed line (1042c). The ONT 1032c may also generate an instance of an alarm clear indicator. In response, the PON card 1020b revises its scorecard 1080b to reflect the changed DHCP alarm state of the ONT 1032c (e.g., by removing the “X” from the column labeled “2.3”).

Referring to FIG. 10C, when a failure condition associated with the set state of the DHCP alarm 1042b is resolved, the ONT 1032b changes the DHCP alarm 1042b to a reset state as indicated by a dashed line (1042b). In response, the PON card 1020b revises its scorecard 1080b to reflect the changed DHCP alarm state of the ONT 1032b (e.g., by removing the “X” from the column labeled “2.2”).

Referring to FIG. 10D, when a failure condition associated with the set state of the DHCP alarm 1042a is resolved, the ONT 1032a changes the DHCP alarm 1042a to a reset state as indicated by a dashed line (1042a). The PON card 1020b may then revise its scorecard 1080b to reflect the changed DHCP alarm state of the ONT 1032a (e.g., by removing the “X” from the column labeled “2.1”). At this point, the scorecard 1080b indicates to the PON card 1020b that the DHCP alarms 1042a-c associated with all subtending ONTs 1032a-c are in the reset state. In response, the PON card 1020b may change the consolidated DHCP alarm 1052 to a reset state (“DHCP.ONT.2 Clear”) as indicated by a dashed line (1052). The PON card 1020b may also forward a consolidated DHCP alarm clear indicator. The OLT processor 1015 (“CPU”) may update its scorecard 1085 to indicate that the consolidated DHCP alarm 1052 has changed to the reset state (e.g., by removing the “X” from the column labeled “2”).

In FIGS. 10E-10G, ONTs 1031a-c may change the DHCP alarms 1041a-c to a reset state (as indicated by dashed lines (1041a-c)) when a failure condition associated with the set state of the DHCP alarms 1042a-c is resolved. The PON card 1020a may revise its scorecard 1080b to reflect the changed DHCP alarm states of the ONTs 1031a-c (e.g., by removing the “X”s from the columns labeled “1.1”, “1.2”, and “1.3”, respectively). As in FIG. 10D, in FIG. 10G, the scorecard 1080a indicates to the PON card 1020a that the DHCP alarms 1041a-c associated with all subtending ONTs 1031a-c are in the reset state. In response, the PON card 1020a may change the consolidated DHCP alarm 1051 to a reset state (“DHCP.ONT.1 Clear”) as indicated by a dashed line (1051). The OLT processor 1015 (“CPU”) may update its scorecard 1085 to indicate that the consolidated DHCP alarm 1051 has changed to the reset state (e.g., by removing the “X” from the column labeled “1”).

After all consolidated DHCP alarms have been set to the reset state as indicated by the OLT scorecard 1085 (e.g., a table in OLT memory), the OLT processor 1015 (“CPU”) changes the first further consolidated DHCP alarm 1060 to a reset state (“DHCP.ONT Clear”). The OLT processor 1015 may also forward a further consolidated DHCP alarm clear indicator to an IPMI 1017. The IPMI 1017, in turn, may change the second further consolidated DHCP alarm 1070, which represents the first further consolidated DHCP alarm 1060, to a reset state (“DHCP Clear”).

Examples of state indicators include alarms, non-alarm events, and threshold crossing alerts (a non-alarm event). An alarm may be an alerting indication to a condition that may have immediate or potential negative impact on the state of a monitored managed entity or network element. Alarms are typically standing conditions that may be cleared by some autonomous event. An event may be an informative indication to a condition on the state of the monitored managed entity. Unlike an alarm, however, an event may not be cleared. But, a “cleared event” can be generated.

A Threshold Crossing Alert (TCA) is a notification to a condition that has exceeded a threshold for a current collection interval or period. A TCA may be an event that may not be cleared in an automated manner, for example, as described above in reference to state indicators.

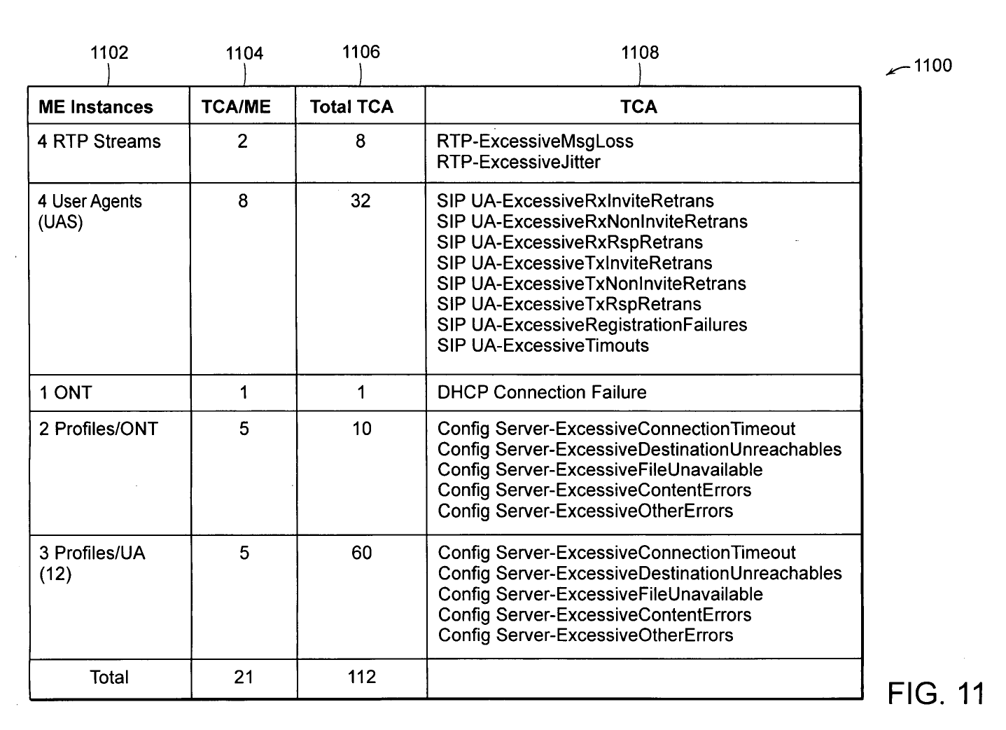

FIG. 11 is a table 1100 of example Session Initiation Protocol (SIP) TCAs 1108 according to one embodiment of the present invention. SIP TCAs may monitor Internet Protocol (IP) Layer (Layer 3) statistics. An OLT is a Data Link Layer (Layer 2) device and is thus unaware of Layer 3. The table 1100 includes columns indicating Managed Entity (ME) Instances 1102, the number of TCAs per ME Instance 1104, the total number of TCAs 1106, and a listing of the TCAs 1108.

The SIP TCAs 1108 may include two TCAs associated with each of four Real-time Transport Protocol (RTP) streams (8 total TCAs). The SIP TCAs 1108 may further include: (1) eight SIP User Agent (UA) TCAs associated with each of four UAs (32 total TCAs); (2) one DHCP TCA associated with an ONT; (3) five Configuration Server TCAs associated with each of a trusted anchor profile and a local-network profile of the ONT (10 total TCAs); and (4) five Configuration Server TCAs associated with each of a device profile, an application profile, and a user profile for each of the four UAs (60 total TCAs). Thus, each ONT may generate up to 112 SIP TCAs and an OLT connected to 1664 ONTs may receive up to 112×1664=186,368 SIP TCAs.

Events, including events outside the control of the EMS, may cause all ONTs to generate large numbers of TCAs every fifteen minutes (e.g., up to 186,368 SIP TCAs). Large numbers of TCAs may quickly overwhelm EMS resources and be useless to the network operator.

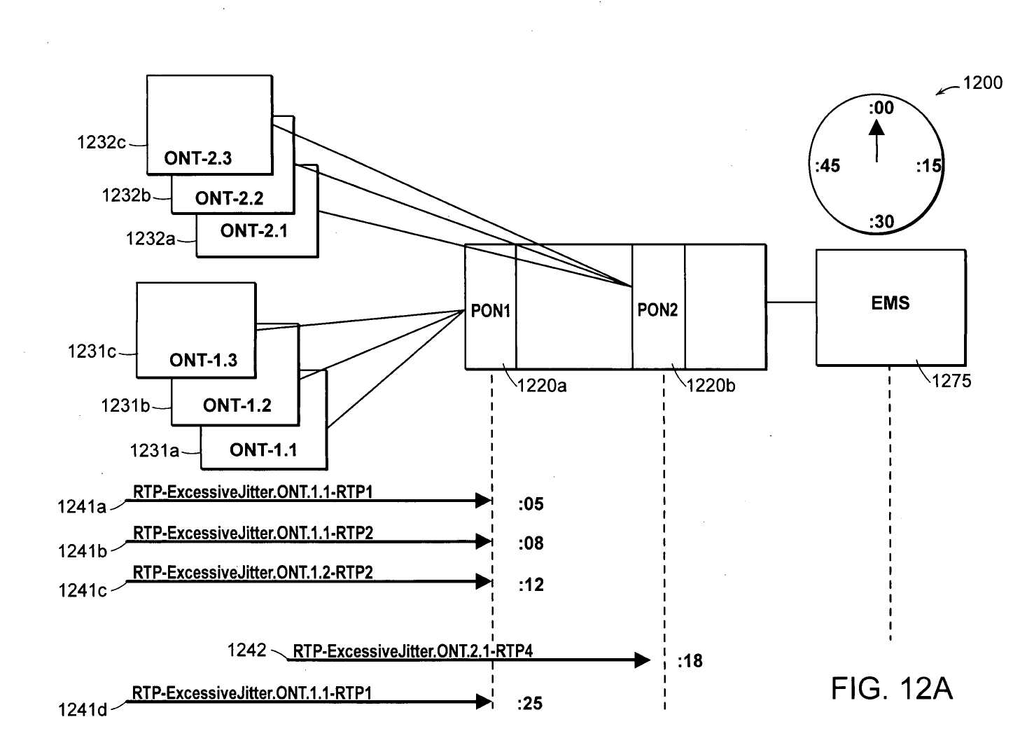

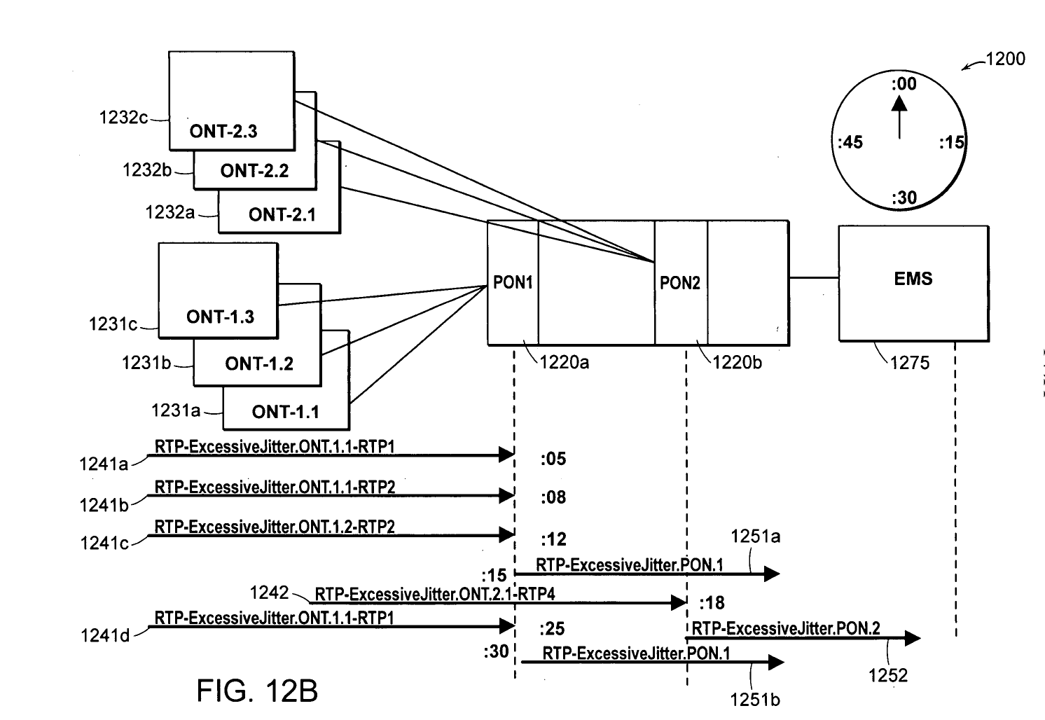

FIGS. 12A and 12B are network diagrams of a portion of an optical communications system 1200 illustrating alert (e.g., TCA) consolidation according to one embodiment of the present invention. An EMS 1275 may provision the same TCA threshold(s) for each type of ME instance (e.g., the same threshold for all four SIP UAs) and some or all ONTs 1231a-c, 1232a-c. Each ME instance (e.g., one ONT, four RTPs, four SIP UAs, and five Profiles) may independently monitor and forward TCAs. For example, all four RTP streams may exceed the excessive jitter threshold, in which case four RTP excessive jitter TCAs are sent from the same ONT to the PON card. Moreover, all four RTP streams from all ONTs on a PON card may exceed the excessive jitter threshold, in which case a total of 128 RTP excessive jitter TCAs are sent from the ONTs to a single PON card. In another example, the ONT 1231a may send two different RTP excessive jitter TCAs 1241a-b to PON card 1220a, and another ONT 1231b may send an RTP excessive jitter TCA 1241c to the same PON card 1220a within a fifteen minute interval, as shown in FIG. 12A. In a subsequent fifteen minute interval, the ONT 1232a may send an RTP excessive jitter TCA 1242 to PON card 1220b and ONT 1231a may send another RTP excessive jitter TCA 1241d to PON card 1220a.

FIG. 12B illustrates an example method of reducing the number of TCAs ultimately received by the EMS 1275. According to this example method, only one TCA of any one type (e.g., RTP, SIP UA, Config Server) is ever sent from the PON cards 1220a-b. Specifically, the PON cards 1220a-b may consolidate multiple ME instances of the same type from the same ONT and consolidate TCAs of the same type from all ONTs. For example, as described above, the PON card 1220a may receive two different RTP excessive jitter TCAs 1241a-b from ONT 1231a and an RTP excessive jitter TCA 1241c from another ONT 1231b within a fifteen minute interval. According to an example alert consolidation method, the PON card 1220a forwards a consolidated RTP excessive jitter TCA 1251a to the EMS 1275 at the end of the fifteen minute interval.

Within a subsequent fifteen minute interval, yet another ONT 1232a may forward an RTP excessive jitter TCA 1242 to the second PON card 1220b, and the respective ONT 1231a may forward an RTP excessive jitter TCA 1241d to the first PON card 1220a. At the end of the fifteen minute interval, the second PON card 1220b may forward a consolidated RTP excessive jitter TCA 1252, and the first PON card 1220a may forward a consolidated RTP excessive jitter TCA 1251b to the EMS 1275. In an optical communications system, the collection interval or period may be anywhere from fifteen minutes to 24 hours, but can be more or less time in other embodiments.

Each PON card 1220a-b may transmit a consolidated TCA with a unique offset to differentiate consolidated TCAs. The PON cards 1220a-b may also include ONT details in their consolidated TCAs.

The above example alert consolidation method limits the number of TCAs forwarded to the EMS 1275. For example, as described above, without alert consolidation, a PON card may receive up to 112 TCAs from each of 32 ONTs and thus may forward up to 112×32=3584 total TCAs to the EMS 1275. In contrast, a PON card applying TCA consolidation as described herein may forward up to 16 TCAs (i.e., two TCAs associated with the RTP steams+eight TCAs associated with the UAs+one TCA associated with the ONT+five TCAs associated with the profiles) to the EMS 1275. Thus, the EMS 1275 may receive up to a total of 832 TCAs from 52 PON cards. In a TCA storm, however, up to 832 consolidated TCAs can still overwhelm the OLT alarm and event manager and the EMS.

In a further embodiment, the PON cards may bypass the OLT alarm and event manager and send one or more messages that represent a bit map of some or all outstanding TCAs on some or all PON cards directly to the EMS at the end of each fifteen minute interval.

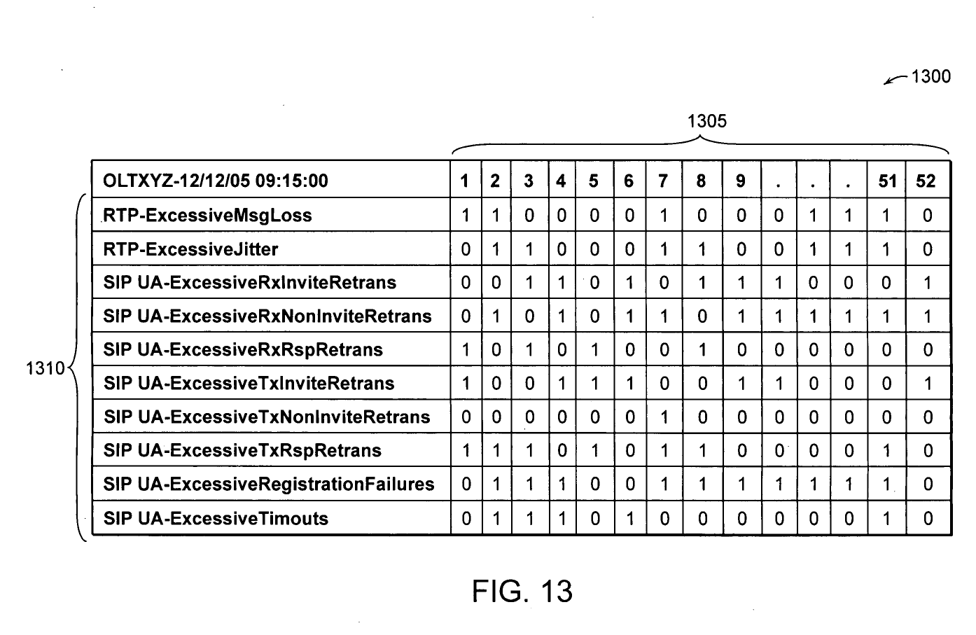

FIG. 13 is an example TCA bit map 1300 for an optical communications system, such as the optical communications system of FIG. 1, according to a further embodiment of the present invention. The example TCA bit map 1300 includes columns 1305 indicating PON cards and rows 1310 indicating consolidated TCAs. A bit is set where a given column 1305 (i.e., a PON card) and a given row 1310 (i.e., a TCA) intersect to indicate whether a given consolidated TCA for a given PON card is outstanding.

While this invention has been particularly shown and described with references to example embodiments thereof, it will be understood by those skilled in the art that various changes in form and details may be made therein without departing from the scope of the invention encompassed by the appended claims.

For example, the flow diagrams of FIGS. 5-7 may include a subset of the flow diagrams, a different order of the flow diagrams, additional sections of the flow diagrams, and so forth, on a per application basis.

It should be understood that the terms “when” and “upon” as used above may be interpreted to mean “immediately after” or “after a nonzero time period.”

It should also be understood that alarms or events of same, similar, or different types may be consolidated into a consolidated alarm or event. For example, the alarms or events of different types may be consolidated if there is some commonality between or among the alarms or events.

It should also be understood that various elements described above may be combined into a single element. For example, the OLT processor 815 and IPMI 817 of FIG. 8 may be combined into a single element or device.

Although embodiments of the present invention are illustrated in contexts of optical communications networks, it should be understood that embodiments of the present invention apply to any type of network (e.g., wired networks, wireless networks, data networks, and so forth) in which status (e.g., alarm, event, etc.) indicators can be consolidated. Further, the networks may be any type of network configuration, such as hierarchical, distributed, ring, and so forth.

Flow diagrams, such as FIGS. 5-7 are merely example embodiments and may be reorganized, have more or fewer blocks, have detailed flows within the blocks or a subset of the blocks, and so forth. The example flow diagrams disclosed herein may be implemented in hardware, firmware, or software. If implemented in software, the software may be instructions stored on any form of computer-readable medium, such as RAM, ROM, or CD-ROM, loaded by a processor, and executed by the processor. The instructions may be physically distributed on the medium or downloaded via a network.

What is claimed is:

1. A network comprising:
a plurality of first network nodes; and
a second network node configured to monitor state indicators of at least a subset of the plurality of first network nodes and configured to forward at least one consolidated state indicator to another network node based on a given state of at least one of the state indicators.

2. The network according to claim 1 wherein the second network node includes a reporting unit that reports at least one of the state indicators in response to a query from a third network node.

3. The network according to claim 1 wherein the second network node (i) forwards the at least one consolidated state indicator based on a first occurrence of the given state of at least one of the state indicators and (ii) stores additional occurrences of the given state of at least one of the state indicators in memory.

4. The network according to claim 1 wherein the second network node forwards the at least one consolidated state indicator based on a hierarchy of state indicators.

5. The network according to claim 1 wherein the state indicators are consolidated state indicators.

6. The network according to claim 1 wherein the second network node comprises:
a monitoring unit configured to monitor the state indicators; and
a mapping unit configured to map the state indicators to the at least one consolidated state indicator based on the given state of at least one of the state indicators.

7. The network according to claim 6 wherein the mapping unit is configured to map the state indicators to the at least one consolidated state indicator based on a first occurrence of the given state of at least one of the state indicators.

8. The network according to claim 7 wherein the second network node further comprises memory that stores additional occurrences of the given state of at least one of the state indicators.

9. The network according to claim 1 wherein (i) the first network nodes are network devices and the second network node is an Optical Network Terminal (ONT), (ii) the first network nodes are ONTs and the second network node is a Passive Optical Network (PON) card, (iii) the first network nodes are PON cards and the second network node is an Optical Line Terminal (OLT), (iv) the first network nodes are network devices and the second network node is a PON card, (v) the first network nodes are ONTs and the second network node is an OLT, or (vi) the first network nodes are network devices and the second network node is an OLT.

10. The network according to claims 1 wherein the first network node(s) are integrated into the second network node.

11. The network according to claim 1 wherein the state indicators represent at least one of the following states: an alarm state, an alarm reset state, a non-alarm event, or a threshold crossing alert.

12. A method of managing state indicators in a network comprising:
monitoring state indicators representing status of at least a subset of a plurality of network nodes;
consolidating the state indicators into at least one consolidated state indicator based on a given state of at least one of the state indicators; and
forwarding the at least one consolidated state indicator.

13. The method according to claim 12 further comprising reporting at least one of the state indicators in response to a query.

14. The method according to claim 12 wherein consolidating the state indicators includes consolidating the state indicators based on a first occurrence of the given state of at least one of the state indicators.

15. The method according to claim 14 further comprising storing additional occurrences of the given state of at least one of the state indicators.

16. The method according to claim 12 wherein consolidating the state indicators includes consolidating the state indicators based on a hierarchy of state indicators.

17. The method according to claim 12 wherein consolidating the state indicators includes consolidating consolidated state indicators.

18. The method according to claim 12 wherein consolidating the state indicators includes mapping the state indicators to the at least one consolidated state indicator.

19. The method according to claim 12 wherein the state indicators represent at least one of the following states: an alarm state, an alarm reset state, a non-alarm event, or a threshold crossing alert.

20. The method according to claim 12 wherein the network nodes are (i) network devices, (ii) ONTs, or (iii) PON cards.

21. A network node comprising:
a monitoring unit configured to monitor state indicators of at least a subset of a plurality of network node elements;
a mapping unit configured to map the state indicators to at least one consolidated state indicator based on a given state of at least one of the state indicators; and
a reporting unit coupled to the mapping unit and configured to report the at least one consolidated state indicator to another network node.

22. The network node according to claim 21 wherein the mapping unit is configured to map the state indicators to the at least one consolidated state indicator based on a first occurrence of the given state of at least one of the state indicators.

23. The network node according to claim 22 further comprising memory that stores additional occurrences of the given state of at least one of the state indicators.

24. The network node according to claim 21 wherein the network node elements are (i) network devices, (ii) ONTs, or (iii) PON cards.

25. A method of managing state indicators in a network node comprising:
monitoring state indicators representing status of at least a subset of a plurality of network node elements;
mapping the state indicators to at least one consolidated state indicator based on a given state of at least one of the state indicators; and
forwarding the at least one consolidated state indicator to another network node.

26. The method according to claim 25 wherein mapping the state indicators includes mapping the state indicators based on a first occurrence of the given state of at least one of the state indicators.

27. The method according to claim 26 further comprising storing additional occurrences of the given state of at least one of the state indicators.

28. The method according to claim 25 wherein the network node elements are (i) network devices, (ii) ONTs, or (iii) PON cards.
